(19) United States
(12) Patent Application Publication
(10) Pub. No.: US 2011/0074811 A1
(43) Pub. Date: Mar. 31, 2011

(54) Map Layout for Print Production

(75) Inventors: Eric Hanson, Emeryville, CA (US); Nikhil Bhatt, Cupertino, CA (US)

(73) Assignee: Apple Inc.

(21) Appl. No.: 12/567,475

(22) Filed: Sep. 25, 2009

(51) Int. Cl. G09G 5/00; G06F 3/048

(52) U.S. Cl. 345/629; 715/810

(57) ABSTRACT

A computing device includes a memory configured to store digital images. The computing device also includes a processor configured to execute instructions to perform a method that includes receiving a collection of digital images in which one or more of the digital images has an associated location. The method also includes displaying a digital map that is defined by a geographic area that includes the associated locations of the digital images. The method further includes annotating the digital map to include one or more identifiers. One or more of the identifiers represents a group of the associated locations as determined from a scale associated with the digital map.

### BACKGROUND

The disclosure related to a system for preparing and adjusting digital maps for laying out print products (e.g., books) for documenting e.g., travels and captured images.

In the ever expanding fields of personal computing and electronic devices, more and more features and functionality are being incorporated into portable devices. For example, cellular telephones and personal digital assistants (PDAs) may include cameras (for gathering images and video) while still providing traditional capabilities (e.g., telecommunications, storing personal information such as calendars, etc.). Due to their robust processing and computational resources, such devices may collect a significant amount of digital imagery (e.g., digital photographs and video). Along with storing such digital information, organizing and presenting the imagery can be a challenge.

### SUMMARY

Disclosed herein are systems and methods for preparing digital maps that indicate the locations associated with digital images. Locations may be associated with images based on various reasons, for example, a location may be where an associated image was captured. Position information (e.g., global position system (GPS) information) may also used to associate images and locations. By using location information associated with the images, interactions with a user, or other techniques, digital maps may be produced that identify each image associated location. Further, using data that is substantially resolution independent, the maps may be scaled to appropriately resolve each location. Once finalized by the user, the digital maps and the corresponding digital images may be prepared for printed productions or other types of layouts.

In some implementations, a method includes receiving a collection of digital images in which one or more of the digital images has an associated location. The method also includes displaying a digital map that is defined by a geographic area that includes the associated locations of the digital images. The method further includes annotating the digital map to include one or more identifiers. One or more of the identifiers represents a group of the associated locations as determined from a scale associated with the digital map.

In other implementations, a computing device includes a memory configured to store digital images. The computing device also includes a processor configured to execute instructions to perform a method that includes receiving a collection of digital images in which one or more of the digital images has an associated location. The method also includes displaying a digital map that is defined by a geographic area that includes the associated locations of the digital images. The method further includes annotating the digital map to include one or more identifiers. One or more of the identifiers represents a group of the associated locations as determined from a scale associated with the digital map.

In other implementations, one or more computer readable media store instructions that are executable by a processing device, and upon such execution cause the processing device to perform operations that include receiving a collection of digital images, wherein one or more of the digital images has an associated location. Execution of the instructions also cause the processing device to perform operations that include displaying a digital map that is defined by a geographic area that includes the associated locations of the one or more digital images. Execution of the instructions also cause the processing device to perform operations that include annotating the digital map to include one or more identifiers, wherein at least one of the identifiers represents a group of the associated locations as determined from a scale associated with the digital map.

These and other aspects and features and various combinations of them may be expressed as methods, apparatus, systems, means for performing functions, program products, and in other ways.

Other features and advantages will be apparent from the description.

### DESCRIPTION OF DRAWINGS

FIG. 1 illustrates a series of images associated with a traveled path.

FIG. 2 illustrates a system for producing a digital map associated with images.

FIG. 3 illustrates a modifiable digital map associated with images.

FIG. 4 illustrates scaling a digital map.

FIGS. 5 and 6 illustrate graphical user interfaces.

FIG. 7 is a flow chart that represents operations of a map producer.

FIG. 8 represents a computer system and related components.

Like reference symbols in the various drawings indicate like elements.

### DETAILED DESCRIPTION

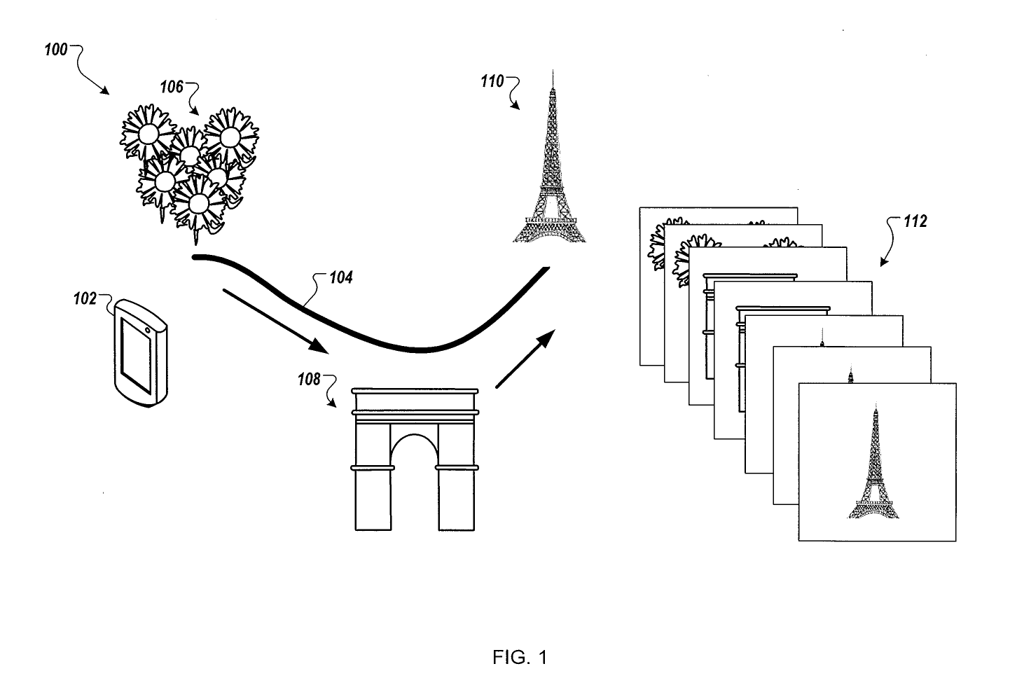

Referring to FIG. 1, an illustration 100 shows a series of exemplary scenes that may be experienced by an individual while traveling along a path. By carrying a portable computing device such as a digital camera, a cellular telephone, a personal digital assistant (PDA) or other similar device capable of collecting image, digital photographs or other types of digital images may be captured while progressing along the path. Along with the captured images, other types of information may collected such as time and position information. For example, global positioning system (GPS) technology, wireless fidelity (Wi-Fi) or other types of wireless technology may be used in conjunction with the portable computing device to track the movement of the individual. In one arrangement, a cell phone 102 incorporates a GPS receiver and computational resources (e.g., processor, memory, etc.) for processing and storing coordinates (e.g., latitude and longitude coordinates) that represent that global position of the portable mobile device. As such, data is collected and preserved on the portable mobile device that represents the location of the device as each image is captured. Similarly, an internal clock or a received timing signal (e.g., satellite based) may be used to provide the time and date that each image was captured. In some arrangements, such time and position data is embedded into the appropriate digital image for later retrieval and use. For example, such time and position information may be represented with metadata, or other type of information structure, which is associated with each captured image. While position information may be associated with a digital image based upon the capture location of the image, other situations may create an association between position information and a digital image. For example, position information may be assigned to a digital image (e.g., by user interactions with a computing device) at a time after the image was captured. A software application may be used to produce and assign position information to images. In some instances the position information associated with a digital image may not reflect the precise capture location of an image but may represent the general area where the image was captured. Similarly, other information such as time and date may be associated with a digital image after the image has been captured (e.g., by a software application).

In this particular illustration, the individual carrying cell phone 102 progresses along path 104 and captures images (with an incorporated camera) at various points of interest. While this example describes individual images (e.g., photographs) being collected, other types of imagery (e.g., video) may also be collected with cell phone 102. In this example, the individual is located in Paris, France and path 104 passes the individual through a series of landmarks such as the Jardins Des Tuileries gardens (represented by flowers 106), which may provide various rural scenes of the local nature. Stopping along the way, images of the garden may be collected using the camera functionality of cell phone 102. Along with collecting the images, additional information may be collected. For example, many portable computing devices like cell phone 102 include an internal clock that provides the time (and date) at each instance an image is captured. As such, data representing the time (e.g., month, day, hour, minute, second) that the image is captured is also collected and grouped with the image data (e.g., inserted into metadata). Other types of collected data may include parameters associated with the cell phone (e.g., serial and model number), collection parameters (e.g., image resolution) and other similar information.

As the individual continues to travel (and carry cell phone 102), position data is collected along with additional images captured. For example, at approximately the midpoint of the traveled path 104, the individual may pass by another landmark such as the Arc De Triomphe 108. Similarly, the individual may pause and capture one or more images of this Paris landmark along with collecting time and position information. Continuing on, the individual may conclude the trip by stopping at another landmark, the location of the Eiffel Tower 110 (in this particular example). Similar to the other locations visited, images may be captured of this landmark along with related information (e.g., position of the capture location, day and time when image capture occurred). As mentioned, this associated information (e.g., location information, day and time, etc.) may be assigned to the digital images at a later time.

In this arrangement, at the conclusion of the travel, significant amounts of information may be stored in cell phone 102. For example, along with captured images 112, associated location information, and day and time stamps may also be stored in memory onboard cell phone 102. As such, information may reside on cell phone 102 that represents sights experienced along the traveled path 104 and information that represents the location of the sights. Often to review the events of a trip, an individual cycles through the captured images and possibly adjusts the image sequence to correlate with the order that sights were visited. However, by capturing a significant number of images and traveling in a somewhat meandering manner, the correlation between the path traveled and the captured images can become confused. As such, the individual may be unable recall the sequence that the images were captured and the path traveled. For such situations, the individual may be unable to fully explain (to another) the path traveled or even be unable to retrace the traveled path (e.g., for returning to the starting point) since the collected images may be of little or no help. However, by using the associated position, time and date information (that correspond to each image), the captured images and locations visited can be correlated. Further, by combining the images, the position and time information, and a digital representation of a map, a graphical presentation may be produced that allows the locations of the images to be quickly identified along with the traveled path. Further, the combined information may be presented in various forms and mediums, for example, a graphical representation of the map and the identified image locations may be presented on a computer display. In another example, the information may be incorporated into various print products (e.g., hard or soft bound books) that may be purchased by the individual who originally captured the images.

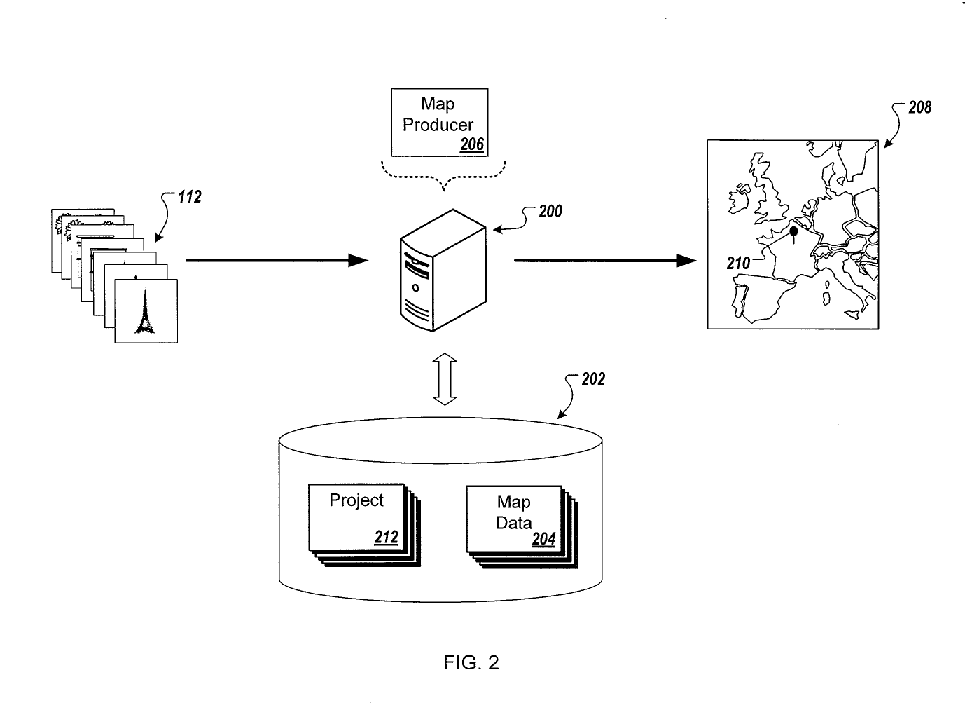

Referring to FIG. 2, a computer system is presented for processing the captured images and associated information to generate print product layouts. One or more techniques may be used to provide captured images 112 to a computer system 200 (e.g., a server). For example, hard-wire connections (e.g., USB) or wireless connections with cell phone 102 may be implemented to transfer the data (e.g., image content, position data, time and date stamps, etc.). Various networking techniques and systems may also be used for data transfer. For example, captured images 112 may be directly uploaded to computer system 200 from another computing device (e.g., the individual's personal computer, cell phone 102, etc.) or by way of one or more networks (e.g., local area networks, wide are networks, the Internet, etc.). Once provided, computer system 200 may store the transferred data at one or more storage devices such as storage device 202 (e.g., memory, a hard drive, CD-ROM, etc.).

To produce a graphical representation such as a digital map, computer system 200 also accesses data that represents locations that may be included in a map. In this arrangement, map data 204 is stored in storage device 202, which may also store the received images (e.g., images 112) along with position and time information. However, in some arrangements this information may distributed among multiple storage devices or preserved by other data storing techniques (e.g., storing the information at other locations via one or more networks).

In this arrangement, map data 204 allows graphical map representations to be produced that are resolution independent. For example, global maps (e.g., maps that include representations of multiple countries) and national maps (e.g., maps that include regions of a nation) may be produced. Continuing down in scale, maps may also be produced at the state, county and city level. Scaling even further down, street level and neighborhood maps could be produced that resolve individual properties (e.g., building, homes, businesses, etc.). One or more techniques may be implemented to produce maps of such relatively large and small scales. For example, map data 204 may represent a collection of polygons that represent the shapes of each feature on the planet. Such a collection may include hundreds of thousands or even millions of polygons to represent the individual shapes. Used individually or in combination, the polygons can produce large scale shapes (e.g., the geographical shape of France) and represent small features (e.g., small islands, river bends, lakes, etc.). Since polygons are used to represent the shapes, various mathematical operations may be executed for scaling and combining the polygons to produce a map of appropriate resolution.

To process the information associated with the images 112 (e.g., image content, associated position information and time, etc.) and map data 204, computer system 200 executes a map producer 206. Along with one or more software components (e.g., functions, processes, etc.), hardware components (e.g., circuitry, processors, etc.) may be used individually or in concert with the software to provide the functionality of map producer 206. Various operations may be executed for map production, for example, map producer 206 may access information associated with the captured images (e.g., position and time) to determine the associated location with respect to the map data 204. Operations may also be executed on map data 204, for example, map producer 206 may accordingly select the polygons needed to present the locations associated with images 112. By selecting only the polygons needed to represent the locations of the images, map producer 206 filters unneeded polygons and thereby conserves computations resources (e.g., processing time and memory space) of computer system 200. Further, by selecting needed polygons in a relatively efficient manner, map producer 206 may quickly identify polygons needed to increase the scale of a map and appropriately execute operations to process the polygons to produce the larger scale (e.g., provide zoom out capabilities).

While collected images 112 may provide position information, which can be used by map producer 206 to determine the needed scale, such information may also be provided from other sources. For example, user interactions with map producer 206 may also provide location information. In one arrangement, map producer 206 may receive user interactions from a graphical user interface (GUI) that is accessed by the individual that provided the images 112. The individual may type the term, e.g., “France” into a GUI to alert map producer 206 to the general location that the images were captured. Since all of the images were captured in Paris, the user may insert more focused terms e.g., “Paris, France” into the GUI to provide the general location that the images were captured. To assist the user, auto-sensing techniques may be implemented for easily recognizing locations such as Paris. Assistance may also be provided by one or more graphical techniques, for example, the user may be provided a series of menus for selecting the general location associated with the images (e.g., the capture location). By using a selection tool (such as a mouse driven pointer), a user may manipulate (e.g., zoom in and zoom out) presented graphics to identify an appropriate region for a digital map. For example, by selecting a graphical representation for France, the map producer 206 may zoom in to display the individual regions and cities of France. Since the polygons used to provide the displayed digital map (of France) can be quickly accessed, map producer 206 can relatively quickly produce a digital map of a region of interest (at substantially any scale). Further, by allowing the user to interact with displayed digital maps, dynamic zooming in and out of the maps is provided.

In this particular arrangement, a digital map 208 is generated by map producer 206 and represents the general region that images 112 are associated (e.g., Paris, France). To indicate these associated locations, digital map 208 is annotated with a graphical pin 210. The geographical position of graphical pin 210 may have been provided by the position information associated with the images 112. The location of graphical pin 210 may also be provided from user interactions. For example, through a GUI, a user may have selected the general location of Paris, France by translating across a representation of a digital map of the globe and by using zoom in and out capabilities provided by map producer 206.

Once associated with digital map 208 (as represented by graphical pin 210), the images and the position data may be incorporated into one or more graphical representation that implement various types of medium. For example, map producer 206 may represent the images and information in a project 212 that catalogs other travels of the user. In one arrangement, project 212 may contain information associated with various global or European travels of the user and digital map 208 and images 112 may be inserted as one chapter (e.g., “A trip to Paris, France”) in the project. Project 212 may provide many uses for the stored images and information, for example, the material may be viewed, edited and used to produce print products. For example, bound books (e.g., hard bound, soft bound, wire bound, etc.) books may be produced from the information included in project 212. Other types of operations that use project 212 may also be executed by map producer 206, for example, the content of the project may be combined with content from one or more other projects.

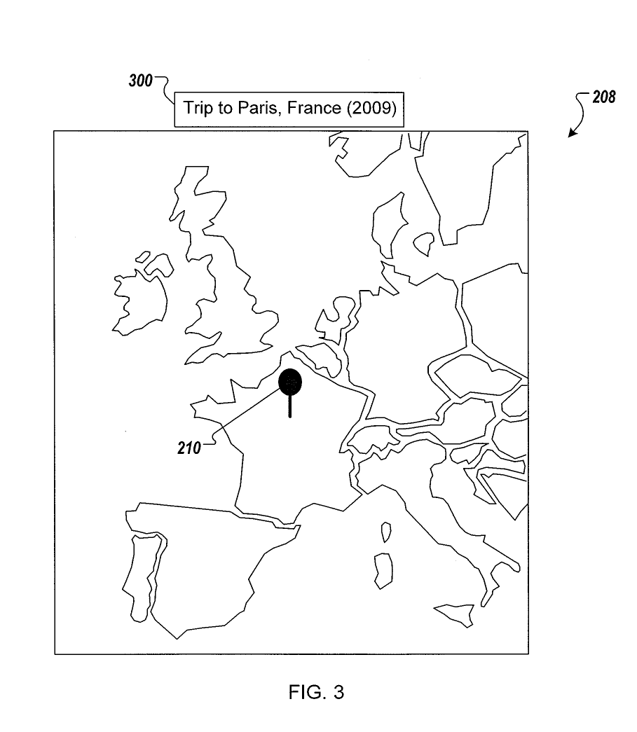

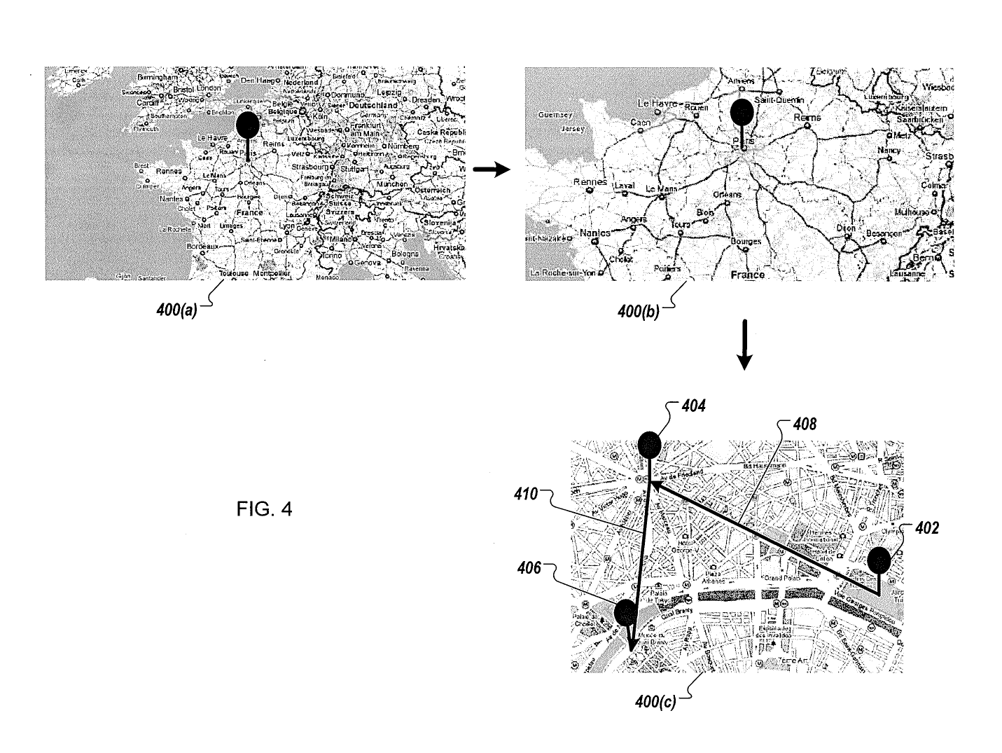

Referring to FIG. 3, while generating digital map 208, map producer 206 may execute operations directed to both the content to be included in the map and the presentation of the map. For example, once provided the position information (of the images) map producer 206 may determine the approximate center of the digital map. Further, from the distribution of the image position information, map producer 206 may determine an appropriate scale for the map. As illustrated in FIG. 4, in one arrangement, a maximum scale may be selected such that all of the position information is resolved on a single map. Centering and scaling of a digital map may also be initiated by other types of information. For example, information provided by a GUI (e.g., user enters the phrase “Paris, France”) may be used to determine the map center. Further, by providing information that identifies multiple locations, map producer 206 may determine an appropriate scale for the map. Along with initially determining map parameters such as center and scale, map producer 206 may also adjust the parameters, for example, when additional information is provided. In one arrangement, upon being provided one or more additional images (with corresponding position information), map producer 206 may use the newly provided information to adjust a previously produced digital map. For example, to appropriately represent the image capture location on the map, map producer 206 may re-scale the map. Similarly, based upon the location provided by the image capture position information, map producer 206 may shift the center of the map. To provide such adjustments, map producer 206 may use various mathematical operations such as interpolation and estimation. Once appropriately adjusted, map producer 206 may initiate the rending of the adjusted map along with other operations (e.g., storing the adjusted map).

Map producer 206 may provide other operations for producing and adjusting digital maps such as digital map 208. For example, graphical properties of digital map 208 may be adjusted. Properties of presented text (e.g., font, size, color, style, etc.) may be adjusted by map producer 206 as directed through user interactions or by predefined preferences. Presented colors and textures of portions of digital map 208 may also be adjusted through user interactions with map producer 206. For example, a GUI may be provided that allows a user to control the style of a map to be rendered (e.g., fill colors, adjust shading, texture, gradient, etc.). Some of the adjustable map portions include the content of the map (e.g., presented color of an individual country or state, etc.), presentation graphics (e.g., the color of a border that frames the map) and other data associated with the map. One or more stylistic effects may also be applied to various map portions by map producer 206 based upon the content of the map. For example, particular styles may be applied to particular map regions (e.g., one set of style settings may be applied to the European region of a map while another set of styles are applied to the Asian region of the map). Application of different styles may also depend upon information associated with the user. For example, one or more styles may be applied to regions (e.g., defined by geography, geo-political geography, etc.) visited by the user. Such styles associated with a map may be implemented by utilizing one or more techniques. For example, the styles and style adjustments may be represented in one or more extensible markup language (XML) layers. Map producer 206 may also allow various graphics to be added to a digital map (e.g., as directed by a user). For example, textual information (e.g., map title, labels for points of interest, notes for describing the map, favorite locations, etc.) such as label 300 and graphics (e.g., a graphical representation of a compass) may be added in an editable form. Map content may also be adjusted by map producer 206. For example, a menu (or other type of graphical tool) may be presented such that a user may select types of content that may be included or removed from a map. In one arrangement, a series of radio buttons may be provided for toggling presented content such as contours (e.g., elevation contours), bodies of water (e.g., rivers, lakes, inland waters), transportation information (e.g., graphical representations of streets, highways, airports), landmarks (e.g., natural occurring and constructed), etc. In some arrangements, map producer 206 may form an association between a digital map and one or more file or documents. For example, an itinerary or other document associated with a trip may be associated with a digital map. By combining the information, along with viewing the images from a trip, a user can trace their travels with the itinerary information.

Referring to FIG. 4, a series of three digital maps 400(a), (b) and (c) are shown that illustrate the scaling capability of map producer 206. From the position information (e.g., geographical coordinates) associated with the images, map producer 206 may identify the approximate center of a digital map. In this particular arrangement, all of the sites associated with the images are located in Paris, France. As such, map producer 206 uses one or more techniques (e.g., estimation) to determine the geographical center of the associated image location. In this particular example, a center location falls geographically between the locations of the Jardins Des Tuileries, the Arc De Triomphe and the Eiffel Tower. With the center location (and corresponding coordinates) identified, map producer 206 may execute operations on the appropriate polygons of map data 204 produce a digital map that is centered on this location. Further, map producer 206 manipulates the appropriate polygons to magnify the center location (e.g., zoom in) until each of the associated image locations is resolved. For illustration, map producer 206 zooms in from a representation of Europe, shown by digital map 400(a), to a representation that resolves individual regions of France, shown by digital map 400(b). While map producer 206 zooms from digital map 400(a) to map 400(b), the center location (Paris) is retained. To resolve the associated locations, map producer 206 continues to manipulate the appropriate polygons (e.g., estimate and interpolate). While still centered on equivalent coordinates used to center maps 400(a) and (b), digital map 400(c) illustrates three graphical pins 402, 404 and 406 that corresponding identify the locations of the Jardins Des Tuileries, the Arc De Triomphe and the Eiffel Tower. While rather simplistic graphics are used for the graphical pins 402, 404, 406, in some arrangements other types of graphics may be implemented. For example, various types of graphic icons may be used to assist viewing by forming a quick association between the map and the locations. A small icon of a flower could be used in place of graphical pin 402 and correspondingly an icon of an arch could be used in place of graphical pin 404 and an icon of a tower could replace graphical pin 406. Other types of graphics may also be used to represent the capture locations, for example, smaller versions of the captured images (e.g., thumbnail images) or textual information (e.g., initials such as “ET” for Eiffel Tower) may be implemented with or without graphical information.

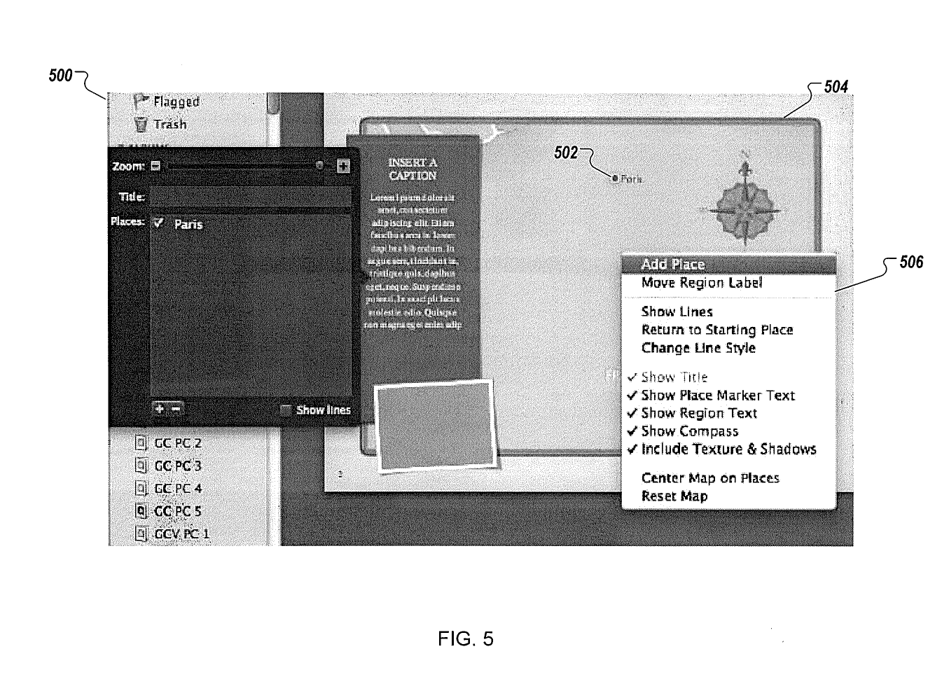

Similar to larger scale maps, map producer 206 also allows aspects of digital maps such as map 400(c) to be adjusted. For example, map features (e.g., streets, landmarks, rural areas, marine areas, etc.) may be represented with various adjustable colors, textures and other types of graphics. Along with the positions of the image capture locations, other information may also be represented on digital map 400(c). For example, by processing the time and date information associated with the images, map producer 206 may determine the sequence that the locations associated with the images (e.g., the capture locations) were visited. In this illustration, photographs were first captured at the Jardins Des Tuileries, then at the Arc De Triomphe, and lastly at the Eiffel Tower. As such, map producer 206 may identify the visit sequence for these landmarks and graphically represent the sequence. For example, one graphical line 408 is included with digital map 400(c) to indicate the distance and direction traveled from the Jardins Des Tuileries (represented by graphical pin 402) to the Arc De Triomphe (represented by graphical pin 404). Similarly, map producer 206 also includes a graphical line 410 to represent the distance and direction traveled from the Arc De Triomphe (represented by graphical pin 404) to the Eiffel Tower (represented by graphical pin 406). Other information and types of information may also be represented on digital map 400(c). Graphical icons may be placed upon the map by a user, for example, icons (e.g., a knife and fork, a bed, etc.) may be positioned at particular locations to represent locations visited (e.g., restaurants, hotels, etc.), for example, where images were not captured. As such, various types of graphical markers may be directly added by a user to a map (e.g., selecting one or more locations with a pointing device such as a mouse). Referring to FIG. 5, a GUI 500 is shown that illustrates various types of graphical information that may be presented. For example, based upon the location of a graphical pointer (e.g., as controlled by a mouse) an identifier 502 is added directly to digital map 504 to represent geographic location of Paris, France. A menu 506 allows a user to control the presentation of particular graphics. For example, a title associated with digital map 504, text associated with identifier 502, text associated with a region of digital map 504, a graphical compass, texture and shadow graphics, and other types of graphics may be represented. For example, textual labels and blocks may also be added by a user to provide context and further memorable details associated with the represented travels.

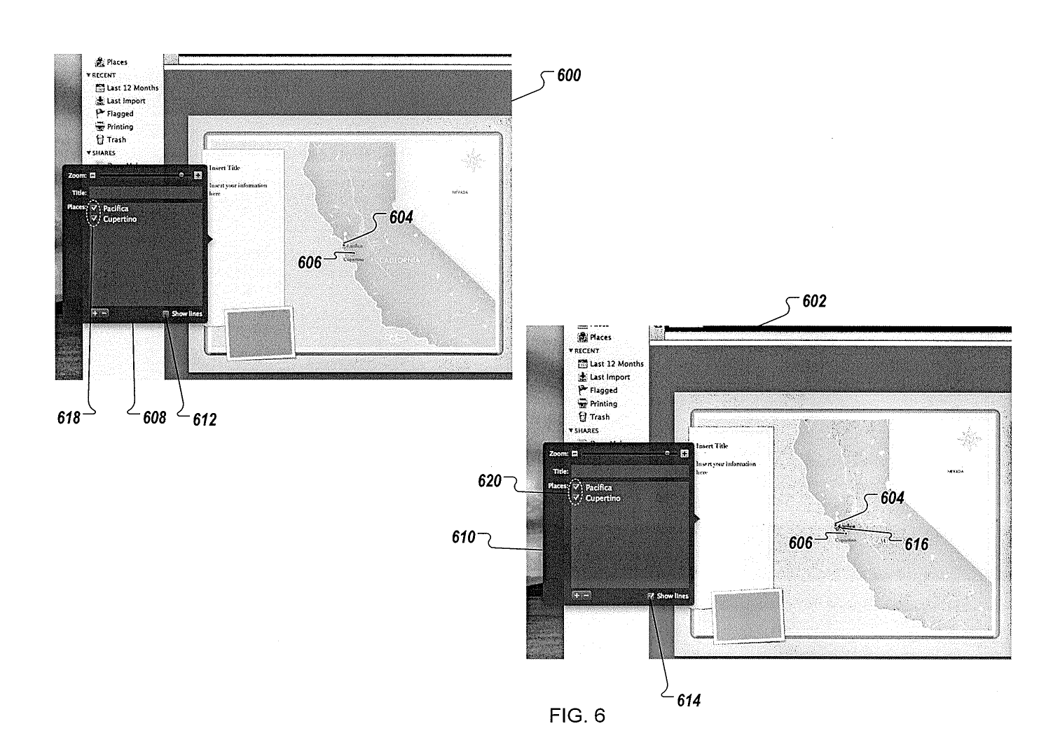

Referring to FIG. 6, a pair of GUI's 600, 602 are presented that each include a pair of identifiers 604 and 606 that represent two separate locations (e.g., Pacifico, Calif. and Cupertino, Calif.). In this illustration each of the identifiers represents a particular location associated with multiple digital images. For example, identifier 604 identifies one location (e.g., Pacifico, Calif.) that is associated with a series of digital images (e.g., 10 images captured at locations within Pacifico) and identifier 606 identifies another location (e.g., Cupertino, Calif.) that is associated with another series of digital images (e.g., 20 images captured at locations within Cupertino, Calif.). Rather than provide individual identifiers for each image, each identifier 604, 606 is respectively associated with a group of images. As such, a viewer of either GUI 600, 602 is not presented a tight cluster of identifiers (for each image) but a single identifier that represents a group of images. One or more techniques may be implemented for grouping images and associating the grouped images with a single location. For example, map producer 206 may determine to group images based upon the scale of the digital map being presented. As the scale of the presented geometry increases, map producer 206 may determine that identifiers (that represent individual images) are obscuring each other (e.g., in contact, overlapping, etc.) and produce a single identifier to represent the tightly grouped individual identifiers.

Similar to the graphical lines 408 and 410 (shown in FIG. 4), one or more graphical lines may be illustrated on GUIs 600, 602 to represent the sequence that each location was visited. In this arrangement, each GUI respectively includes a menu 608, 610 that allows a user to select one or both of identifiers 604, 606 for presentation. Menus 608 and 610 also include respective selection boxes 612, 614 that activate the presentation of graphical lines (labeled “Show Lines”). In this illustration, the graphical lines are not activate (as indicated by the unchecked selection box 612) in GUI 600 and are activated (as indicated by checked selection box 612) in GUI 602. As such, GUI 602 includes a graphical line 616 with an arrowhead that represents the sequence that the two locations were visited. To determine the sequence, map producer 206 may implement one or more techniques. For example, time and date information associated with the images may be used to indicate which location was first visited. In some arrangements, the sequence may correspond to the order that the locations are listed in the respective menus (e.g., first Pacifica, second Cupertino). Such listed sequence orders may be user-selectable. Menus 608 and 610 also include selections boxes 618 and 620 that allow the user to select the locations to be presented. For example, by selecting (e.g., with a pointing device) the respective boxes 618, 620, a user may toggle between presenting each of the identifiers 604, 606 or not. As such, identifiers 604, 606 may be added and removed from the digital map.

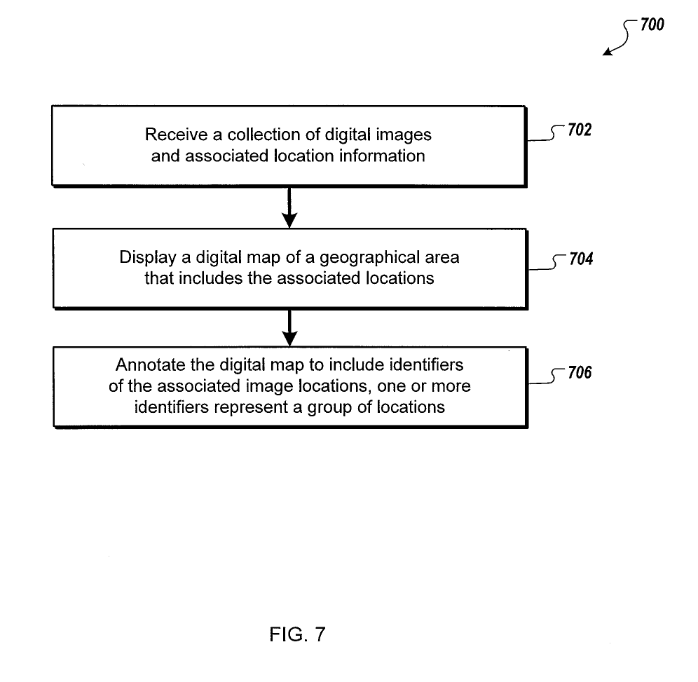

Referring to FIG. 7, a flowchart 700 represents some of the operations of map producer 206 (shown in FIG. 2). The operations may be executed by a single computing device (e.g., computer system 200) or multiple computing devices. Operations may include receiving 702 a collection of digital images and associated location information. Typically location information is received for each digital image, however, in some arrangements information for a subset of the images may be received. Location information may identify the actual location, the general vicinity that an image was captured or another associated location. Operations also include displaying 704 a digital map of a geographical area that includes the location information. To identify the geographical area, one or more techniques may be implemented. For example, location information associated with the images may be used by map producer 206 for identifying the region. User interactions (e.g., information provided by a user through a GUI) may also be used for identifying the geographical region. For example, a user may select a general geographical region and the received location information may be used to make appropriate adjustments (e.g., scale, shift, etc.). Other graphical parameters may also be determined from the location information to produce the digital map. The geographical center, scale and other parameters of the map may be determined from the location information. For example, location information associated with the images may be used to establish the boundaries of the geographical region to be displayed. Offset distances, orientation adjustments, etc. may also be used for setting boundaries to appropriately frame the presented region. By operating (e.g., interpolating, combining, etc.) on an appropriate subset of polygons (from a polygon set that represents the shapes of each global region), the digital map may be produced. Operations also include annotating 706 the digital map to include identifiers of the associated image locations. Graphical pins, icons, thumbnail versions of the images and other types of graphics may operate as identifiers. In some arrangements, one or more of the identifiers represent a group of locations associated with corresponding images. For example, based upon the scale of the digital map, locations associated with the images may appear tightly clustered. As such, individual identifiers may overlap and may not be distinguishable to a viewer. By representing such clusters of identifiers with individual “group” identifiers, a viewer's understanding of the digital map may be assisted. Once annotated, the digital map may be used for various applications. For example, the digital map may be prepared for use in one or more print productions (e.g., travel map books). However, to prepare the digital map for such productions, map producer 206 may use a higher resolution to produce an appropriate file (e.g., one or more “.pdf” files) that complies with software used for producing print products.

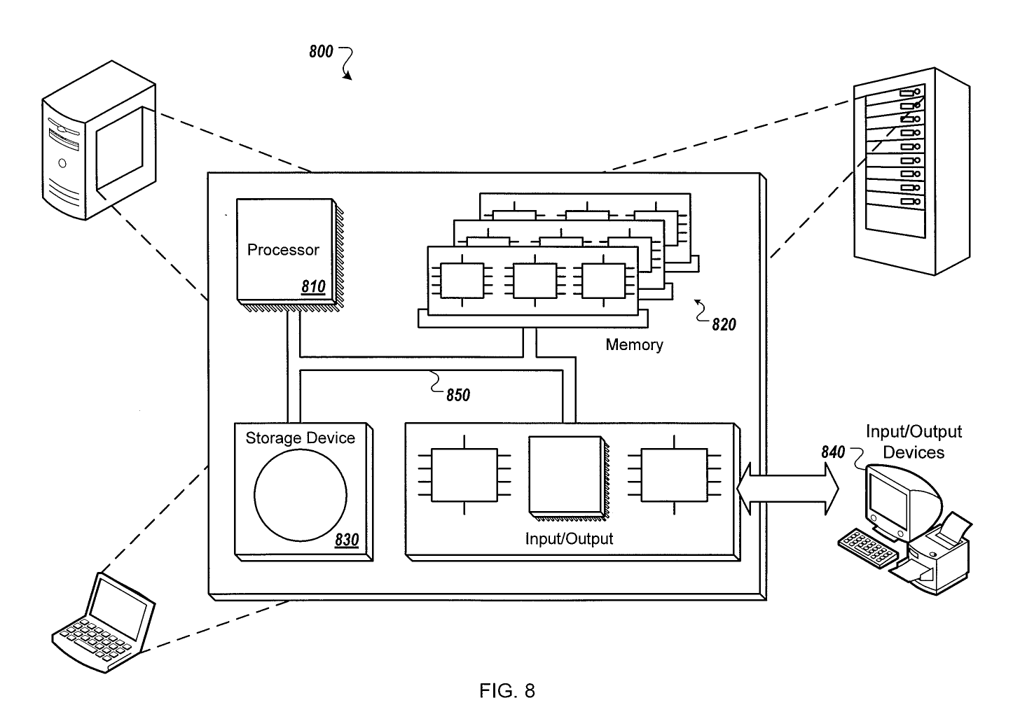

Referring to FIG. 8, a schematic diagram of a generic computer system 800 is illustrated. The system 800 can be used for the operations described in association with any of the computer-implemented methods described previously, according to one implementation. The system 800 includes a processor 810, a memory 820, a storage device 830, and an input/output device 840. Each of the components 810, 820, 830, and 840 are interconnected using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the system 800. In some implementations, the memory 820 is a computer-readable medium. The memory 820 is a volatile memory unit in some implementations and is a non-volatile memory unit in other implementations.

The storage device 830 is capable of providing mass storage for the system 800. In one implementation, the storage device 830 is a computer-readable medium. In various different implementations, the storage device 830 may be a floppy disk device, a hard disk device, an optical disk device, or a tape device.

The input/output device 840 provides input/output operations for the system 800. In one implementation, the input/output device 840 includes a keyboard and/or pointing device. In another implementation, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Other details and features combinable with those described herein may be found in the following U.S. patent application entitled “Organizing Digital Images based on Locations of Capture”, filed on 21 Aug. 2009 and assigned Ser. No. 12/545,765. The entire contents of the aforementioned application is hereby incorporated by reference.

A number of implementations have been described. Nevertheless, it will be understood that various modifications may be made without departing from the spirit and scope of the following claims. For example, the techniques described herein can be performed in a different order and still achieve desirable results.

1. A method comprising:
receiving a collection of digital images, wherein one or more of the digital images has an associated location;
displaying a digital map that is defined by a geographic area that includes the associated locations of the one or more digital images; and
annotating the digital map to include one or more identifiers, wherein at least one of the identifiers represents a group of the associated locations as determined from a scale associated with the digital map.

2. The method of claim 1, wherein displaying the digital map includes determining a geographic center of the digital map based upon the associated locations of the one or more digital images.

3. The method of claim 1, further comprising:
adjusting the digital map based upon the introduction of an additional digital image.

4. The method of claim 3, wherein adjusting the digital map includes adjusting the geographic center of the digital map.

5. The method of claim 3, wherein adjusting the digital map includes adjusting the scale of the digital map.

6. The method of claim 1, wherein displaying the digital map includes scaling the digital map to resolve each of the identifiers.

7. The method of claim 1, wherein the digital map is displayed at a resolution associated with a print product.

8. The method of claim 1, wherein one of the identifiers is a graphical icon.

9. The method of claim 1, wherein the geographic area is identified by user interaction.

10. The method of claim 1, wherein annotating the digital map includes adding a title to the digital map.

11. The method of claim 1, wherein annotating the digital map includes removing the identifier that represents the group of the associated locations.

12. The method of claim 1, wherein the digital map is produced from resolution independent data.

13. A computing device comprising:
a memory configured to store digital images; and
a processor configured to execute instructions to perform a method comprising:
receiving a collection of digital images, wherein one or more of the digital images has an associated location;
displaying a digital map that is defined by a geographic area that includes the associated locations of the one or more digital images; and
annotating the digital map to include one or more identifiers, wherein at least one of the identifiers represents a group of the associated locations as determined from a scale associated with the digital map.

14. The computing device of claim 13, wherein displaying the digital map includes determining a geographic center of the digital map based upon the associated locations of the one or more digital images.

15. The computing device of claim 13, wherein the method further comprises:
adjusting the digital map based upon the introduction of an additional digital image.

16. The computing device of claim 15, wherein adjusting the digital map includes adjusting the geographic center of the digital map.

17. The computing device of claim 15, wherein adjusting the digital map includes adjusting the scale of the digital map.

18. The computing device of claim 13, wherein displaying the digital map includes scaling the digital map to resolve each of the identifiers.

19. The computing device of claim 13, wherein the digital map is displayed at a resolution associated with a print product.

20. The computing device of claim 13, wherein one of the identifiers is a graphical icon.

21. The computing device of claim 13, wherein the geographic area is identified by user interaction.

22. The computing device of claim 13, wherein annotating the digital map includes adding a title to the digital map.

23. The computing device of claim 13, wherein annotating the digital map includes removing the identifier that represents the group of the associated locations.

24. The computing device of claim 13, wherein the digital map is produced from resolution independent data.

25. One or more computer readable media storing instructions that are executable by a processing device, and upon such execution cause the processing device to perform operations comprising:
receiving a collection of digital images, wherein one or more of the digital images has an associated location;
displaying a digital map that is defined by a geographic area that includes the associated locations of the one or more digital images; and
annotating the digital map to include one or more identifiers, wherein at least one of the identifiers represents a group of the associated locations as determined from a scale associated with the digital map.

26. The computer readable media of claim 25, wherein displaying the digital map includes determining a geographic center of the digital map based upon the associated locations of the one or more digital images.

27. The computer readable media of claim 25, further comprising instructions to cause the processing device to perform operations comprising:
adjusting the digital map based upon the introduction of an additional digital image.

28. The computer readable media of claim 27, wherein adjusting the digital map includes adjusting the geographic center of the digital map.

29. The computer readable media of claim 27, wherein adjusting the digital map includes adjusting the scale of the digital map.

30. The computer readable media of claim 25, wherein displaying the digital map includes scaling the digital map to resolve each of the identifiers.

31. The computer readable media of claim 25, wherein the digital map is displayed at a resolution associated with a print product.

32. The computer readable media of claim 25, wherein one of the identifiers is a graphical icon.

33. The computer readable media of claim 25, wherein the geographic area is identified by user interaction.

34. The computer readable media of claim 25, wherein annotating the digital map includes adding a title to the digital map.

35. The computer readable media of claim 25, wherein annotating the digital map includes removing the identifier that represents the group of the associated locations.

36. The computer readable media of claim 25, wherein the digital map is produced from resolution independent data.
